(19) United States
(12) Patent Application Publication
(10) Pub. No.: US 2004/0261855 A1
(43) Pub. Date: Dec. 30, 2004

(54) Pressure regulator with integrated reverse pressure exhaust

(76) Inventors: Justin Wade Hart, Melissa, TX (US); David Blair Davis, Whitewright, TX (US); Gregg Alan Schneider, Corinth, TX (US); Steven Ernest Berry, Conrad, IA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/608,663

(22) Filed: Jun. 27, 2003

(51) Int. Cl. F16K 31/12

(52) U.S. Cl. 137/486

(57) ABSTRACT

A control valve system is disclosed which provides a mechanism by which the valve can be moved to its fail-safe position. The system includes a valve actuator which receives pressurized fluid from a regulator. The regulator is provided with a reverse pressure exhaust valve such that if pressure within the valve actuator is to be alleviated, as when the valve is to be positioned into its fail-safe position, the reverse pressure exhaust valve is opened thereby providing an immediate and accurate passageway through which excess pressure within the regulator outlet can be alleviated.

### FIELD OF THE DISCLOSURE

The present disclosure relates to process control apparatus and, more particularly, relates to regulators for providing pressurized fluid at a predetermined level.

### BACKGROUND OF THE DISCLOSURE

In many process control environments, the flow of the process fluid is regulated by one or more control valves. The control valves themselves can be provided in a number of forms including those using control elements in the form of sliding stems, butterfly plates, and rotary balls to adjust a variably sized opening between an inlet and an outlet of the valve. The control element itself is controlled by an actuator physically coupled to the control element. The actuator can also be provided in a number of forms including those employing a diaphragm with upper and lower pressure chambers flanking the diaphragm. By controlling the pressure differential between the first and second chambers, the diaphragm can be caused to move upwardly or downwardly relative to the control valve and in turn move the diaphragm, associated actuator stem, and control element.

Accordingly, it can be seen that it is important to supply the actuator with fluids at known pressures. In the case of the aforementioned diaphragm actuator, pressurized air is often used as the fluid and is provided by way of a regulator. The regulator includes a housing having an inlet and an outlet, with the inlet being connected to a source of compressed air such as a compressor of the plant in which the regulator is provided. Such plants may be provided in the form of refineries, chemical processing plants, food processing plants, or any other type of process control environment wherein regulation of pressure and flow of fluids is important. The regulator housing further includes an outlet adapted to be connected to the valve actuator with a movable plug situated in the housing between the inlet and the outlet. Depending on the position of the plug within a passageway connecting the inlet to the outlet, the pressure provided by the regulator can either be increased or decreased to a predetermined or known volume for accurate supply to the actuator.

In order to control the flow of such pressurized fluid from the regulator to the actuator, a positioner (sometimes referred to as a controller or an instrument), is provided therebetween. The positioner may receive a signal from a processor of the facility or plant, with that signal being representative of the desired flow of the process fluid. Based on the received control signal, the positioner then determines the required valve position, and allows the pressurized fluid from the regulator to pass to the valve actuator as appropriate to provide the correct valve position and ultimately the desired process fluid flow.

In addition to providing for an accurately regulated level of pressurized fluid to the actuator, such systems also must provide a mechanism by which the control valve can fail into a safe position. As indicated above, such control valves are often used in refineries or chemical processing plants where it is imperative that the valve fail to a safe position. This safe position may mean that the control valve fails to a fully open or fully closed position. In either event, in order for the control valve to reach such a position, the pressurized fluid within the actuator controlling the control valve must be fully dissipated or exhausted from the system. However, as the actuator receives the pressurized fluid from the regulator, it is the regulator which must be provided with some form of mechanism for bleeding the excess pressure from the valve actuator. Methods to improve steady state bleed to atmosphere of the regulator outlet pressure include, but are not limited to, fixed diameter internal and external bleed orifices. However, such designs require that regulator outlet pressure constantly vent to atmosphere thereby creating audible noise from escaping air, creating a higher demand on the compressor system of the plant, and giving false indications of a mechanical defect or failure.

Accordingly, it can be seen that a need exists for an improved regulator design which allows for quick and reliable exhaust of excess regulator outlet pressure when desired.

### SUMMARY OF THE DISCLOSURE

In accordance with one aspect of the disclosure, a pressure regulator is disclosed which may comprise a housing, an inlet, an outlet, a passage, a plug, and an exhaust valve. The inlet and outlet may be provided in the housing with the inlet receiving fluid compressed at a first pressure, and regulating fluid reduced to a second pressure. The passage may connect the inlet to the outlet with the plug being movably mounted in the housing and disposed in the passage. The plug is movable between a range of positions extending from a first position closing the passage to a second position fully opening the passage. The exhaust valve may extend between the outlet and the inlet and be normally closed, but be opened when pressure within the outlet exceeds pressure within the inlet by a predetermined amount.

In accordance with another aspect of the disclosure, a valve system is disclosed which may comprise a control valve, a valve actuator, and a regulator. The control valve may regulate flow of the process fluid, with the valve actuator being coupled to the control valve and being driven by pressurized fluid. The regulator may be operatively associated with the valve actuator and supply fluid at a specific pressure to the valve actuator. The actuator may include an inlet, an outlet, and a movable element therebetween with the regulator further including a reverse pressure exhaust valve adapted to connect the outlet to the inlet when pressure within the outlet is greater than pressure within the inlet by a predetermined amount.

In accordance with another aspect of the disclosure, a method of operating a control valve system is disclosed which may comprise directing pressurized fluid from a regulator to a valve actuator to change the position of a valve actuator, changing the position of a control valve based on the change in position of the valve actuator, and relieving excess pressure from the valve actuator when it is desired to have the control valve move to a certain position. The excess pressure may be exhausted through a reverse pressure exhaust valve provided in the regulator.

These and other aspects and features of the disclosure will become more readily apparent upon reading the following detailed description when taken in conjunction with the accompanying drawings.

### BRIEF DESCRIPTION OF THE DRAWINGS

FIG. 1 is a block diagram depicting a valve system constructed in accordance with the teachings of the disclosure;

FIG. 2 is a sectional view of a regulator constructed in accordance with the teachings of the disclosure; and

FIG. 3 is a sectional view of a reverse pressure exhaust valve provided within a regulator constructed in accordance with the teachings of the disclosure.

While the following detailed description sets forth various modifications and alternative constructions, certain illustrative embodiments thereof have been shown in the drawings and will be described below in detail. It should be understood, however, that there is no intention to limit the disclosure to the specific forms disclosed, but on the contrary, the intention is to cover all modifications, alternative constructions, and equivalents falling within the spirit and scope of the invention as defined by the appended claims.

### DETAILED DESCRIPTION OF THE DISCLOSURE

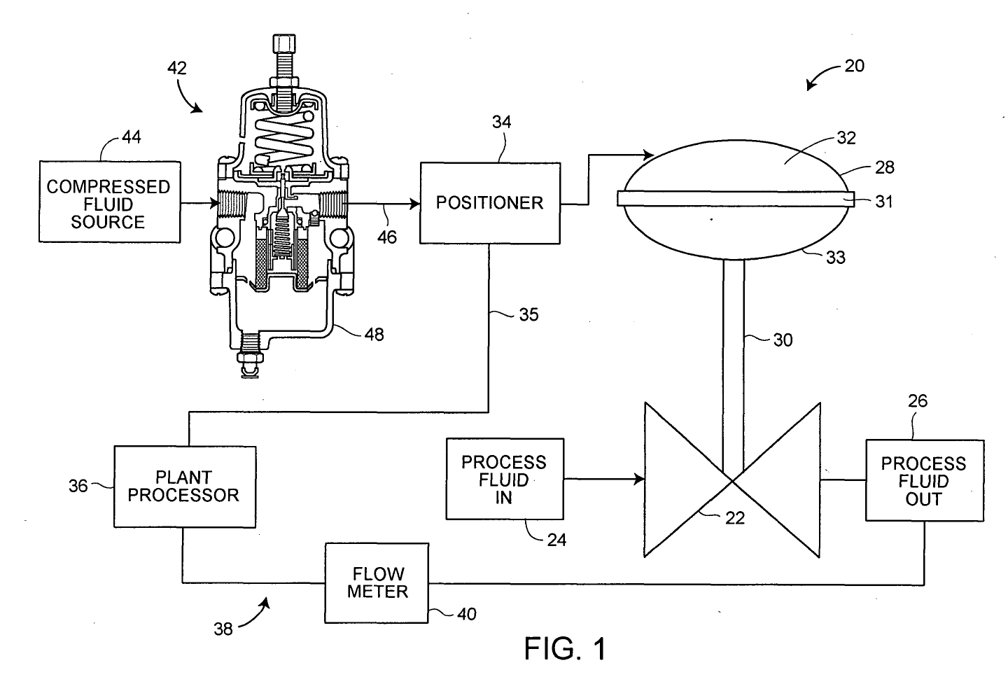

Referring now to the drawings, and with specific reference to FIG. 1, a valve system constructed in accordance with the teachings of the disclosure is generally referred to by reference numeral 20. The valve system can be employed in a variety of different settings including, but not limited to, refineries, chemical processing plants, food processing plants, and the like. In each of the envisioned settings, the valve system 20 can be employed to regulate the flow of a process fluid to a desired pressure, flow rate, and volume.

Referring again to FIG. 1, the valve system 20 is shown to include a control valve 22 adapted to control or regulate flow of a process fluid between an inlet 24 and an outlet 26. As indicated above, the control valve 22 can employ any number of different structures for doing so including, but not limited to, sliding stems, butterfly plates, and rotary balls.

Connected to the control valve 22 is a valve actuator 28, which is so connected by a stem 30, coupled to the control element of the control valve 22. Accordingly, movement of the valve actuator 28 controls the position of the control element of the valve 22 and thus the flow of fluid through the system 20. In order to do so, the valve actuator 28 can be provided in a number of forms including pneumatic or other fluidically operated actuators which employ a diaphragm 31 within a housing and disposed between upper 32 and lower chambers 33. By filling the upper and lower chambers with fluids at disparate pressures, a pressure differential is generated across the diaphragm thereby creating movement of the diaphragm. Movement of the diaphragm 31 in turn causes movement of the stem 30, which in turn causes movement of the control element thus changing the position of the control valve 22.

A positioner 34 is shown connected to the valve actuator 28 for supplying pressurized fluid thereto. More specifically, the positioner 34 provides pressurized fluid to the upper chamber 32 and/or lower chamber 33 of the valve actuator 28 to thus control the position of the diaphragm 31. The positioner 34 may do so after receiving a control signal 35 from a plant processor 36 which may be part of an overall control scheme of the plant or facility in which the valve system 20 is employed. The control signal 35 may be predetermined, or may be based on signals received from a feedback loop 38. As shown in FIG. 1, the feedback loop 38 may employ a flow meter or the like 40 which measures process fluid from the outlet 26. Accordingly, if the measured flow is not as desired, the plant processor 36 can generate a suitable control signal 35 for moving the control valve 22 accordingly and thus make the process fluid flow closer to the desired level.

The positioner 34, as indicated above, provides pressurized fluid to the valve actuator 28 based on the control signal 35. However, the positioner 34 itself receives pressurized fluid from a regulator 42. The regulator 42 receives fluid from a source 44 pressured at a first level, and generates fluid 46 pressured at a second level for receipt by the positioner 34. For example, the source 44 may be compressed air provided by a main air compressor of the plant or facility and may be provided at a pressure on the order of hundreds of pounds per square inch (psi). However, the positioner 34 may only be able to receive pressurized fluid at a much lower psi level. Accordingly, the regulator 42 may be a pressure reduction type of regulator which receives the compressed fluid of the plant at a relatively high psi, and steps the compressed air down to a much lower level for use by the positioner 34.

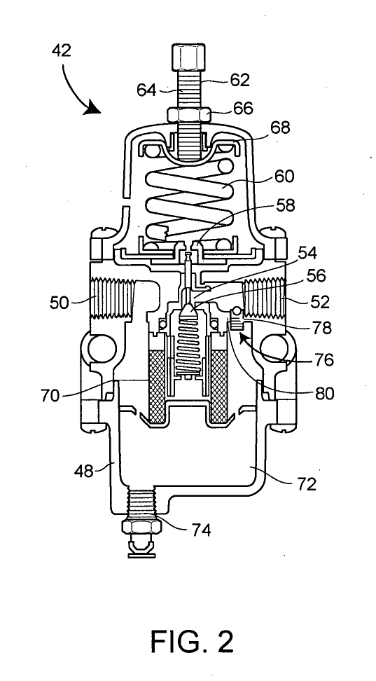

Referring now to FIG. 2, the regulator 42 is shown in further detail. As depicted therein, the regulator 42 includes a housing 48 having an inlet 50 and an outlet 52 with a passageway 54 therebetween. By controlling the cross-sectional area of the passageway 54, the pressure of the fluid flowing through the regulator 42 can be adjusted. This may be done by controlling the position of a moveable plug 56 provided within the passageway 54. While there are a number of different mechanisms by which this movement can be accomplished, it will be noted from FIG. 2 that a moveable plug 56 may be mounted to a plate 58 which, in turn, is movably biased toward the passageway 54 by a spring 60. The degree to which the plate 58 and thus the plug 56 are biased toward the passageway 54 can be adjusted by sizing the spring 60 appropriately, or by adjusting the position of a bolt 62 adapted to impart force on the spring 60. As depicted, the bolt 62 includes a plurality of threads 64, as well as a locking nut 66. Accordingly, as the bolt 62 is rotated, it imparts more or less force upon a top plate 68, which in turn adjusts the degree in which the spring 60 is compressed or pre-loaded.

FIG. 2 also illustrates that the regulator 42 may include a filter assembly 70 within the inlet 50 to reduce the number of particulates passing through the regulator 42 and thus ensuring that the positioner 34 receives relatively clean fluid to thereby prolong its life and improve its accuracy. The regulator 42 may further include a moisture trap 72. The moisture trap 72 may serve as a reservoir for retaining any liquid or condensation removed from the fluid passing through the regulator 42. Accordingly, a drain 74 may be provided within the housing 48 to allow for removal of such liquid.

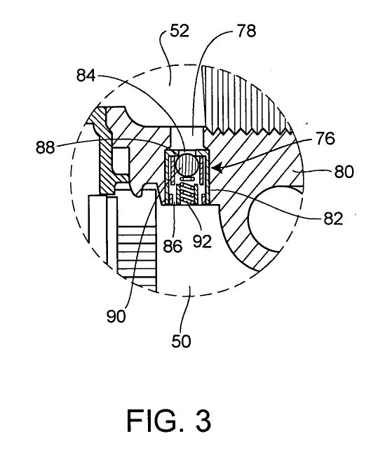

The various chambers of the regulator 42 are provided at different pressures. As the regulator 42 is typically provided in the form of a pressure reduction regulator, wherein the inlet 50 is at a pressure greater than the outlet 52, fluid flow will typically be directed from the inlet 50, through the passageway 54, and through the outlet 52 to the positioner 34. However, as indicated above, it is sometimes necessary for fluid to be evacuated from the outlet 52, or from the positioner 34, or the valve actuator 28. For example, when it is desired for the control valve 22 to fail to a safe position, the control element of the control valve will move either to a fully open or fully closed position. As movement of the control element is controlled by the valve actuator 28, this in turn requires that the upper chamber 32 and/or lower 33 chamber of the valve actuator 28 be fully evacuated to allow for movement of the diaphragm. However, the pressurized fluid can only be evacuated from the valve actuator 28 through the positioner 54 and the regulator 42. As opposed to prior art regulators which provided a bleed orifice within the regulator which constantly bled off excess pressure at the expense of increased audible output, the present disclosure provides an integrated reverse pressure exhaust (IRPE) valve 76 directly within the regulator 42 between the inlet 50 and outlet 52. Specifically, it will be noted that the IRPE valve 76 may be provided within a hole 78 drilled into an interior wall 80 of the housing or body 48. The IRPE valve 76 may be provided in a variety of forms, but in the depicted embodiment shown in FIG. 3, includes a housing 82 having an inlet 84 and an outlet 86 with a valve seat 88 therebetween. A control element 90 such as a ball or the like is biased against the valve seat 88 by a spring 92 in the direction of the inlet 84. The IRPE valve 76 is positioned such that the IRPE outlet 86 is proximate the regulator inlet 50, and the IRPE inlet 84 is proximate the regulator outlet 52.

It can accordingly be seen by one of ordinary skill in the art that the IRPE valve 76 provides a mechanism by which excess pressure within the outlet 52 can be alleviated and thus enable the control valve 22 to reach it desired fail-safe position. This can be accomplished any time the pressure differential between regulator inlet and outlet 50, 52 reaches a predetermined level. The predetermined level may be dictated by the size of the spring 92. In the depicted embodiment, the spring 92 is sized so as to be compressed and thereby open the IRPE valve 76, whenever the pressure within the outlet 52 is greater than the pressure within the inlet 50 by six psi or more. Of course, the IRPE valve 76 can be sized so as to be opened at any other desired pressure differential as well.

In operation, it can therefore be seen that the valve system 20 provides a system by which process fluid can be accurately regulated and controlled between the inlet 24 and outlet 26. This is done by using the valve actuator 28 to control the position of the control valve 22. However, when it is desired for the valve 22 to fail to a fully open or fully closed position, the valve actuator 28 is provided with a mechanism by which excess pressure therein can be quickly and accurately alleviated not only through the positioner 34, but through the regulator 42 as well. This is done by providing the IRPE valve 76 directly within the regulator 42 which is openable whenever the pressure differential within the regulator 42 exceeds a predetermined threshold. Once that pressure differential is reached, the IRPE valve 76 opens and thus the excess pressure within the outlet 52 is relieved, and the valve 22 can reach its fail-safe position. Moreover, once the excess pressure within the outlet 52 is alleviated, the IRPE valve 76 automatically closes, thereby positioning the valve system 20 again for normal operation.

What is claimed is:

1. A pressure regulator, comprising:
a housing:
an inlet in the housing receiving fluid reduced to a first pressure;
an outlet in the housing exhausting fluid compressed at a second pressure;
a passage connecting the inlet to the outlet;
a plug movably connected in the housing and disposed in the passage, the plug being movable between a range of positions extending from a first position closing the passage, to a second position fully opening the passage; and
a reverse pressure exhaust valve in the housing extending between the outlet and the inlet, the reverse pressure exhaust valve being normally closed, the reverse pressure exhaust valve opening when pressure within the outlet exceeds pressure within the regulator inlet by a predetermined amount.

2. The pressure regulator of claim 1, further including a spring in the housing biasing the plug into the fully open position.

3. The pressure regulator of claim 2, further including an adjustment mechanism for changing the degree of bias imparted by the spring.

4. The pressure regulator of claim 1, further including a filter disposed between the inlet and outlet.

5. The pressure regulator of claim 1, further including a moisture trap disposed between the inlet and outlet.

6. The pressure regulator of claim 1, wherein the reverse pressure exhaust valve is a one-way check valve having a movable plug mounted in a housing between an inlet and an outlet with a seat therebetween, a spring biasing the plug against the seat.

7. The pressure regulator of claim 1, wherein the size of the spring determines the predetermined amount, the predetermined amount being approximately six psi.

8. A valve system, comprising:
a control valve regulating flow of a process fluid;
a valve actuator coupled to the control valve, the valve actuator being driven by pressurized fluid; and
a regulator operatively associated with the valve actuator, the regulator supplying fluid at a specified pressure to the valve actuator, the regulator including an inlet, an outlet, and a movable element therebetween, the regulator further including a reverse pressure exhaust valve adapted to connect the outlet to the inlet when the pressure within the outlet is greater than the pressure within the inlet by a predetermined amount.

9. The valve system of claim 8, further including a positioner, the positioner receiving a control signal and directing pressurized fluid from the regulator to the valve actuator based on the control signal.

10. The valve system of claim 8, wherein the reverse pressure exhaust valve is a one-way check valve, the check valve including a housing having an inlet, an outlet, a seat between the inlet and the outlet and a movable valve element biased against the seat by a spring.

11. The valve system of claim 10, wherein the spring biases the valve element toward the control valve outlet.

12. The valve system of claim 8, wherein the predetermined amount is a pressure differential of six psi.

13. The valve system of claim 8, wherein the regulator further includes a spring biasing the regulator movable element into an open position.

14. The valve system of claim 8, wherein the regulator further includes a filter between the inlet and the outlet.

15. The valve system of claim 8, wherein the regulator further includes a moisture trap between the inlet and the outlet.

16. A method of operating a control valve system, comprising:
directing pressurized fluid from a regulator to a valve actuator to change the position of the valve actuator;
changing the position of a control valve based on the change in position of the valve actuator; and
relieving excess pressure from the valve actuator when it is desired to have the control valve fail to a certain position, the excess pressure being relieved through a reverse pressure exhaust valve provided in the regulator.

17. The method of claim 16, wherein the excess pressure is exhausted when the pressure within an outlet of the regulator is greater than the pressure within an inlet of the regulator by a predetermined amount.

18. The method of claim 17, wherein the predetermined amount is six psi.

19. The method of claim 16, wherein: the reverse pressure exhaust valve includes a spring-biased element, the excess pressure being exhausted when the pressure in an outlet of the regulator is greater than the pressure in an inlet of the regulator and a pressure differential therebetween creates a force sufficient to overcome a biasing force of the spring.

20. The method of claim 16, wherein the pressured fluid is directed from the regulator to the valve actuator by a positioner.

21. The method of claim 16, further including a step of having the positioner receive a signal representative of desired control valve position.

22. The method of claim 16, wherein the position of the valve actuator is changed by adjusting the pressure differential in the valve actuator.
